(19) United States
(12) Patent Application Publication
(10) Pub. No.: US 2010/0088131 A1
(43) Pub. Date: Apr. 8, 2010

(54) CONSERVATION APPARATUS, SYSTEMS, AND METHODS

(76) Inventors: Steven W. Lundberg, Edina, MN (US); Gary J. Speier, Eden Prairie, MN (US)

Correspondence Address: SCHWEGMAN, LUNDBERG & WOESSNER, P.A., P.O. BOX 2938, MINNEAPOLIS, MN, 55402, US

(21) Appl. No.: 12/246,889

(22) Filed: Oct. 7, 2008

(51) Int. Cl. G06Q 10/00; G06Q 40/00

(52) U.S. Cl. 705/7; 705/14.42

(57) ABSTRACT

Apparatus, systems, and methods may operate to receive resource consumption data from a plurality of consuming entities. The entities may comprise members of a defined community, such as an online community. Further activities may include publishing an online comparison of at least some of the resource consumption data and/or information derived from the resource consumption data to compare consumption by some number of the consuming entities. Publication, perhaps in the form of a ranked list display, is expected to foster competition between the consuming entities, leading to reduced resource consumption. Additional apparatus, systems, and methods are disclosed.

### BACKGROUND

As the use of various resources increases, the available amount of each resource tends to diminish. As a result, the cost of obtaining additional resources for consumption increases accordingly, perhaps at an accelerated rate when the resources to be consumed become scarce.

### BRIEF DESCRIPTION OF THE DRAWINGS

Some embodiments are illustrated by way of example and not limitation in the figures of the accompanying drawings in which:

FIG. 1 illustrates a graphical user interface (GUI) that may be used to display a ranked comparison of resource conservation efforts according to various embodiments;

FIG. 2 illustrates a GUI that may be used to enter or update resource conservation data according to various embodiments;

FIG. 3 is a flow diagram illustrating several methods according to various embodiments;

FIG. 4 is a block diagram of apparatus and systems according to various embodiments;

FIG. 5 is a block diagram of an article of manufacture, including a machine, according to various embodiments; and

FIG. 6 is a flow diagram illustrating additional methods according to various embodiments.

### DETAILED DESCRIPTION

The inventors have determined that energy, among other resources, can be conserved by encouraging competition for reduced use among selected groups of entities. Interest can be generated, and competition among the entities can be initiated, by publishing the results of conservation efforts to the entities, providing the results as representing specific achievement targets for subsequent efforts. In some cases, prizes in the form of cash or credit may be awarded to those entities that are able to best conserve one or more selected resources, according to some measurable standard.

For the purposes of this document, “consuming entities” comprise one or more persons, groups of persons, societal units, geographic units, or business units that a capable of consuming a resource. Thus, consuming entities include, but are not limited to, individual persons, households, structures (e.g., homes, buildings), blocks, streets, subdivisions, zip codes, map grids, power grids, structure types (e.g., apartments, condominiums, single-family dwellings, duplexes), business types, business associations, clubs, Internet social networking groups, resource type users, cities, counties, states, and countries.

An “online comparison” means, at a minimum, a listing of data that can be accessed via an electronic network to enable a person viewing the list to ascertain, in either an absolute or relative sense, the difference in magnitude between the data values in the list.

The term “rendering” used as a verb includes presenting or making accessible electronic content or content elements to be perceived, viewed, or otherwise experienced by a user, or made available for further processing, such as, for example, searching, digesting, printing, analyzing, distilling, or transforming by computational processes that may not include processing the intrinsic data structure describing the electronic content or content element.

The term “rendering” used as a noun includes human-perceivable representations of data that is within a machine and perception-specialized organizations of data defining such representations. For example, a rendering may include a pattern of human-perceivable matter or energy presented on an output device (e.g., a display) by a machine, as well as the organization of data within a machine that defines such patterns. For example, such organizations of data may include the electronic configuration of a memory used by a graphics display processor, or a file containing an audio segment suitable for playing via an audio system of a computer.

The term “rendering module” may be taken to include systems, applications, and mechanisms for rendering or presenting electronic content to a user, including the presentation of content elements such as text, graphics, form element renderings, scroll bars, and other electronic content elements. An example of a rendering module includes a web browser component (e.g., Microsoft Internet Explorer) or some other component to render electronic content such as HTML pages. Another example of a rendering module includes the ADOBE® ACROBAT® electronic publishing program.

The term “rendering program” includes applications for rendering or presenting dynamic content to a user. An example of a rendering program is the ADOBE® FLASH® Player 9 runtime software application, as well as the Microsoft® Silverlight™ browser plug-in. In many embodiments, a rendering module interacts with a rendering program to render dynamic content. In some embodiments, a rendering module includes a rendering program.

A “resource” is anything that can be selectively consumed. Thus, a few of the more common resource types include electrical energy, fuel, food, and currency. Many other resource types exist, including heat and power, among others.

“Resource consumption data” comprises data that represents the quantity of at least one resource that has been consumed. The resource consumption data may be communicated as absolute values, relative values, or some combination of these.

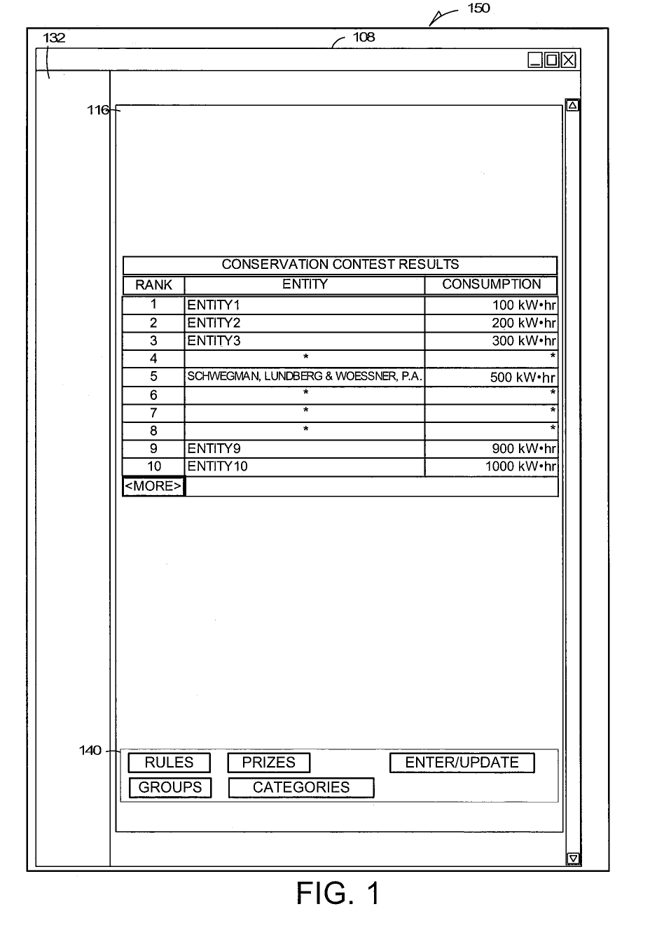

FIG. 1 illustrates a GUI 108 that may be used to display a ranked comparison of resource conservation efforts according to various embodiments. The GUI 108, which may comprise a client GUI displayed on a display surface 150 (e.g., a touch surface or a flat panel display), shows an example of a window 116 that may be displayed by a rendering program to present renderings of conservation contest results. In this case, nine generically identified consuming entities ENTITY1, . . . , ENTITY10 are illustrated as part of a ranked list that is ordered according to the amount of electrical energy consumed over a selected time period (e.g., a day, week, month, quarter, or year). The entity ranked in fifth place is identified by its actual name, as opposed to a generic one.

In the embodiment shown, the consuming entity ENTITY1 is ranked in the highest position, consuming only 100 kW·hr, while consuming entity ENTITY10 is ranked in the lowest position, consuming ten times as much energy, or 1000 kW·hr. By selecting the widget labelled <MORE>, the results for additional consuming entities can be viewed. Any number of consuming entities can be displayed, ranked, and compared in this manner. In some embodiments, one or more utility companies may serve as consuming entities.

In the lower portion of the window 116, several options are presented in the form of additional widgets, as part of a menu selection window 140. For example, to display the rules for a particular conservation contest event (e.g., the one currently displayed as a ranked list), the widget labelled RULES may be selected, perhaps using a mouse or some other user input device.

Similarly, to display the prizes available for a particular conservation contest event, the widget labelled PRIZES may be selected. To view contest results (or rules or prizes) that are active with respect to various groups of consuming entities, the widget labelled GROUPS may be selected. To view contest results (or rules or prizes) that are available with respect to various categories of resources (e.g., specific instances of resource types, such as water), the widget labelled CATEGORIES may be selected.

Finally, if a manual or automatic update of the consumption data for the contest displayed is to be effected, the widget labeled ENTER/UPDATE can be selected. For a manual update, an individual consumer may type in the quantity of a resource that has been consumed, perhaps subject to verification. For example, the amount of electricity or gas consumed at an individual residence might be cross-checked with the amount indicated by a local meter coupled to the device (e.g., a home computer) located at the same residence that renders the GUI 108.

An automatic update process might operate, perhaps on a periodic, timed basis, to query one or more metering devices that gather consumption data, so that it can be uploaded directly to a server that manages the consumption data to be ranked and displayed. A combination of manual and automatic updating may also be used. For example, a user might request an immediate update manually, and then automatic processes would be activated in response to the request to harvest the data.

Various types of information can be displayed to a user on an output device, perhaps including the display surface 150, in various ways according to the nature of the information and/or the preferences of users. For example, a user-updated conservation blog or related news feed might be displayed as part of a side-bar 132. In some such embodiments, a user input device (e.g., a mouse, keyboard, touch screen, touch pad, voice input, etc.) is used to explore the data presented in the GUI 108. A rendering application may provide affordances, such as scroll bars, fast forward/reverse scan buttons, or other GUI elements to be manipulated by the user to carry out data exploration, including viewing, reviewing, and editing functions.

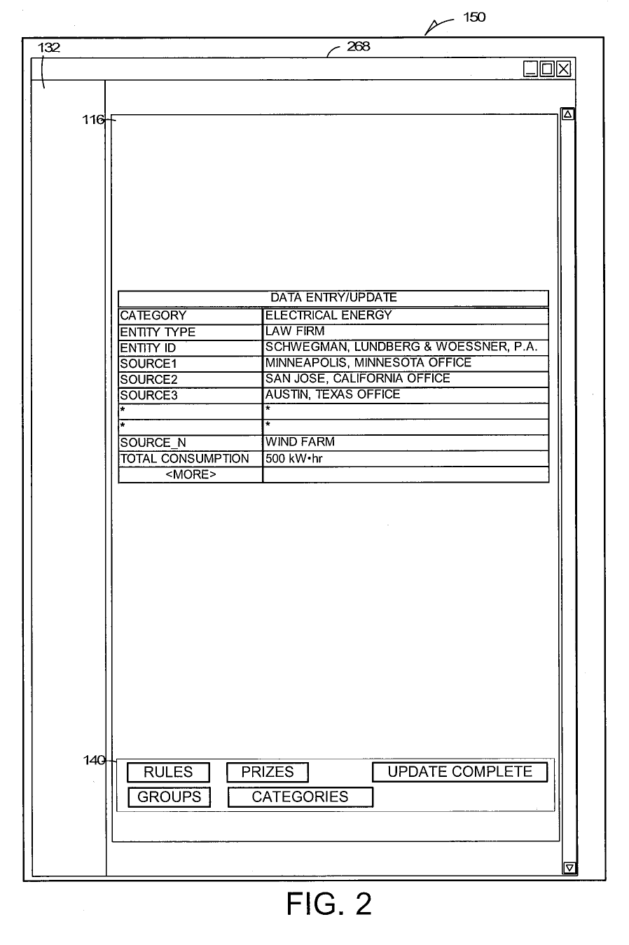

FIG. 2 illustrates a GUI 268 that may be used to enter or update resource conservation data according to various embodiments. In this case, a consuming entity (e.g., the named entity ranked in fifth place in FIG. 1) may have employed a user to select the widget labelled ENTER/UPDATE as part of the GUI shown in FIG. 1, resulting in publication of the GUI 268 of FIG. 2. Several components of the GUI 268 can be noted.

First, the consuming entity identification is given as SCHWEGMAN, LUNDBERG & WOESSNER, P.A., which is consistent with what is shown as the name of the entity in FIG. 1. This consuming entity is further identified by the entity type, which is “LAW FIRM” and the category of consumption, which is “ELECTRICAL ENERGY.”

One or more individual sources of consumption can be associated with the identified entity. For example, here the sources are the offices of the firm located in Minneapolis, Minn., San Jose, Calif., and Austin, Tex. Many other sources may exist, perhaps identified by the type of source, such as that which occurs in conjunction with source SOURCE_N, identified as a wind farm.

The consumption total labeled TOTAL CONSUMPTION for all sources shown on the viewing surface 150 is given as 500 kW·hr. In some embodiments, this total comprises a local total, which is the total of all sources shown in FIG. 2, or a grand total, which includes all of the sources shown in FIG. 2, plus others identified in additional displays, made visible when the widget labeled <MORE> is selected.

This consumption total can be manually entered, automatically entered, or entered via some combination of the two mechanisms, as described previously. When the data for total consumption has been successfully entered, it can be transmitted to an aggregating server or some other receiving entity by selecting the widget labeled UPDATE COMPLETE. Thus, many embodiments may be realized.

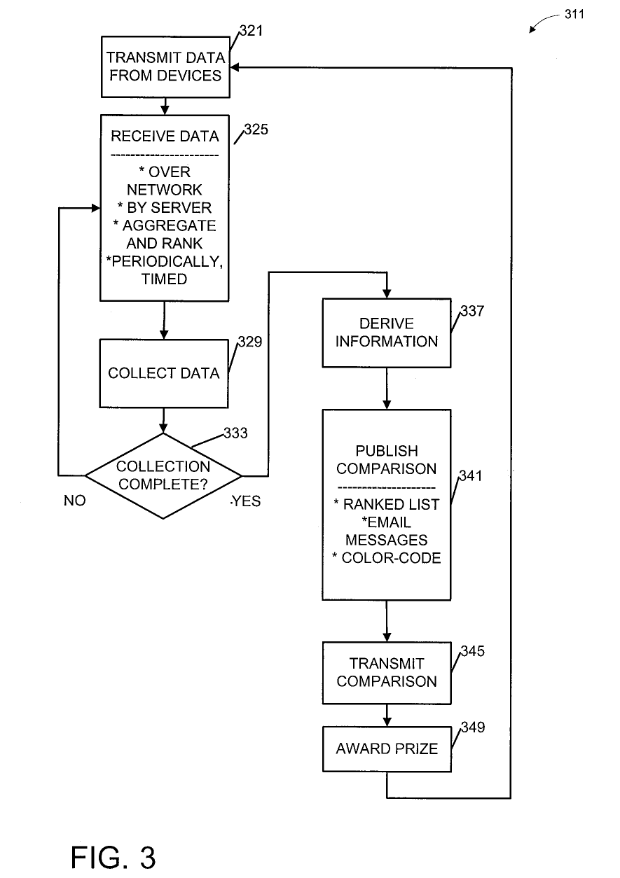

For example, FIG. 3 is a flow diagram illustrating several methods 311 according to various embodiments. The methods 311 are implemented in a machine-accessible and readable medium, and are operational over processes within and among networks. The networks may be wired, wireless, or a combination of wired and wireless. The methods 311 may be implemented as instructions, which when accessed by a machine, cause the machine to perform the processing depicted and described with respect to FIGS. 1-2, as well as additional processing.

Thus, in some embodiments, a computer-implemented method 311 of collecting and publishing resource consumption data may comprise, at block 321, transmitting resource consumption data from a plurality of networked reporting devices comprising at least one of a computer or a data acquisition terminal. Thus, the resource consumption data may be reported via computers, such as desktops or laptops, and/or data acquisition terminals, including specialized terminals, such as smart meters, including the A3 Alpha® meter available from Elster Electricity LLC of Raleigh, N.C.; and the OpenWay™ CENTRON® meter available from Itron, Inc. of Liberty Lake, Wash. Other types of terminals may be used.

The method 311 may go on to include, at block 325, receiving resource consumption data from a plurality of consuming entities, perhaps as members of an online community. An “online community” means a group of entities having access to a network with members of the group identified by login information that is unique as between the individual members of the community.

The activity of receiving at block 325 may comprise receiving the resource consumption data from a plurality of reporting devices over a network that couples the plurality of reporting devices to a publication server. The publication server may operate, in turn, to publish a comparison between the consuming entities, using the consumption data, or information derived from the consumption data. The publication server may be coupled directly, or indirectly, to the reporting devices.

For example, a group of homes in a subdivision may be equipped with smart metering devices that report the consumption data of each household with respect to consumption of power (e.g., electrical power), fuel (e.g., coal or fuel oil), and/or water. The activity of receiving at block 325 may further comprise receiving the resource consumption data by one or more servers, and aggregating and ranking the resource consumption data to provide the comparison. The tasks of aggregation, ranking, and publishing may be divided among a plurality of servers, or be accomplished using a single server, as desired.

The activity of receiving at block 325 may also comprise receiving the resource consumption data on a periodic basis, over a limited time period, or some combination of these. For example, data may be received every minute, hourly, daily, weekly, monthly, quarterly, or annually. Other reception increments may be used.

Data may also be collected for one or more selected time periods, such as during the month of October, which is Energy Conservation Month in the United States of America. The data may be received from one or more types of consuming entities, as noted previously.

Receiving the resource consumption data may occur directly or indirectly. For example, in some embodiments, reporting devices may transmit the data directly to a server that is used to rank and publish the data. In other embodiments, the reporting devices may transmit the data to a first location where it is aggregated to some extent, and the aggregated data is then transmitted on to a second location, where further aggregation takes place, and from which the further aggregated data is sent on to other locations, and so on. In this way, for example, data from a city block might be aggregated for a single block at a first level, and then the aggregated data from all city blocks within a zip code might be further aggregated at a second level, after which the further aggregated data from several zip codes might be ultimately aggregated to provide the result for a city, county, or state, as a political entity. Other levels of aggregation may be used.

The method 311 may include collecting the resource consumption data at block 329, perhaps at a specific location, either virtual or physical. For example, the collection activity at block 329 may include collecting the resource consumption data at a second web site from one or more first web sites where the resource consumption data is originally received (and perhaps aggregated). Thus, the resource consumption data can be received (and aggregated) at multiple web sites, and collected by another web site designated for that purpose. In some embodiments, a web site with multiple members, such as the web site identified by the universal resource locator (URL) www.facebook.com might operate to receive resource consumption data, and then to transmit the received data to another web site, such as one identified by the URL www.conserveyourenergy.com.

If the collection activity of block 329 is complete, as determined at block 333, then the method 311 may continue on to block 337. If the collection activity is not complete, the method 311 may return to block 325 for the reception of additional resource consumption data.

At block 337, the method 311 may include deriving information from the collected resource consumption data. For example, the raw data, such as electricity usage in the form of kW·hr might be converted into a percentage of average usage for a household with the same number of family members. Other forms of information that can be derived in addition to a percentage of use include points (e.g., a numeric scale that partitions usage data linearly, logarithmically, or some other way), relative values, absolute values, converted values (e.g., unit or currency conversion), aggregate values, mixed-resource values (e.g., a combination of water, gas, and electricity consumed), weighted values (e.g., electrical power use might be weighted twice as much as water use), etc.

Deriving the information from the resource consumption data at block 337 may include adjusting the resource consumption data based on one or more factors, such as household size, structure size (e.g., occupied volume, physical volume, rented square footage, taxed square footage, total square footage), group size (e.g., the number of consuming entities of a particular type that exist), business size (e.g., gross income, number of employees), resource cost, resource type, resource provider (e.g., public utility, private cooperative), time of usage (e.g., peak or non-peak, seasonal), climate data, temperature data, rainfall data, or business type. Thus, any number of factors can be used to adjust the raw consumption data to provide comparative information for publication.

The method 311 may continue on to block 341 with publishing an online comparison of at least some of the resource consumption data and/or information derived from the resource consumption data to compare consumption by two, three, or more of the consuming entities. Publication may take place in a variety of ways.

For example, the activity of publishing at block 341 may comprise publishing the comparison as a ranked list, as shown in FIG. 1. The ranked list may be constructed to generically identify the consuming entities associated with the consumption data and/or the information. That is, the consuming entities may be ranked according to a generic identity (e.g., ENTITY1, ENTITY2, . . . , ENTITY_N), where each entity is given information to determine its own generic identity. This practice enables such entities to easily locate their relative performance in a ranked listing that does not include actual identities. However, such entities will be unable to easily determine the actual identities of others that have been so identified.

Actual or coded identification mechanisms, such as URLs, email addresses, phone numbers, employee numbers, customer numbers, or hashed social security numbers, among others, may also be used. This can be seen with respect to the entity ranked in fifth place in FIG. 1, where the actual business name of the entity is used.

The ranked list can be ordered so that consuming entities that consume less of a resource are ranked higher than the consuming entities that consume more of the resource (e.g., as shown in FIG. 1). In this way, the ranked list focuses on reporting those consuming entities that do the best job of conserving a particular resource. Ranking can be accomplished via comparison of absolute, or adjusted consumption data values, or information derived from the data values. Other orders of ranking may also be used.

In some embodiments, the activity of publishing at block 341 includes publishing the comparison as part of an email message to the consuming entities. Thus, for example, publication can occur via email transmission to the consuming entities, a web site publication accessible to the consuming entities, or both. Other methods of publication, such as hardcopy printing or storing the data on a tangible medium, can also be used.

The activity of publishing at block 341 may also comprise publishing the comparison to include a color-coded scale associated with the consumption data and/or the derived information. For example, a three-tiered color scheme may be used as part of a visual scale, with green noting the top tier (best conservators), yellow noting the middle tier (mid-level conservators), and red noting the bottom tier (worst conservators). Other color schemes may be used.

The method 311 may go on to include, at block 345, transmitting the comparison from a first web site where the resource consumption data was originally received, to a second web site. Thus, processing of the received data, to include a comparison and publication of the data, or information derived from the data, may occur at one location, and the comparison result may be transmitted for display at another location.

The method 311 may go on to block 349 to include awarding a prize to one or more winners of a contest based on the comparison. Prizes can include cash, credit (e.g., monetary or resource credit), or other items of value.

Prizes may be based on the absolute best results from the ranked list (e.g., the top three performing entities), or on relative results. For example, if a color-coded scale is used to rank conservation performance, the method 311 may include awarding one or more prizes having a value based on the color-coded scale. At this point, the method 311 may continue on to block 321 to include the transmission and reception of additional resource consumption data that can be used to update published comparisons, if desired. Many other embodiments may be realized.

Those of ordinary skill in the art will realize that each of the method elements shown in FIG. 3 may be combined with the other elements shown in a variety of ways. Such combinations may be used to form a variety of methods that use some or all of the elements from FIG. 3 in serial, parallel, looped, and/or repetitious fashion.

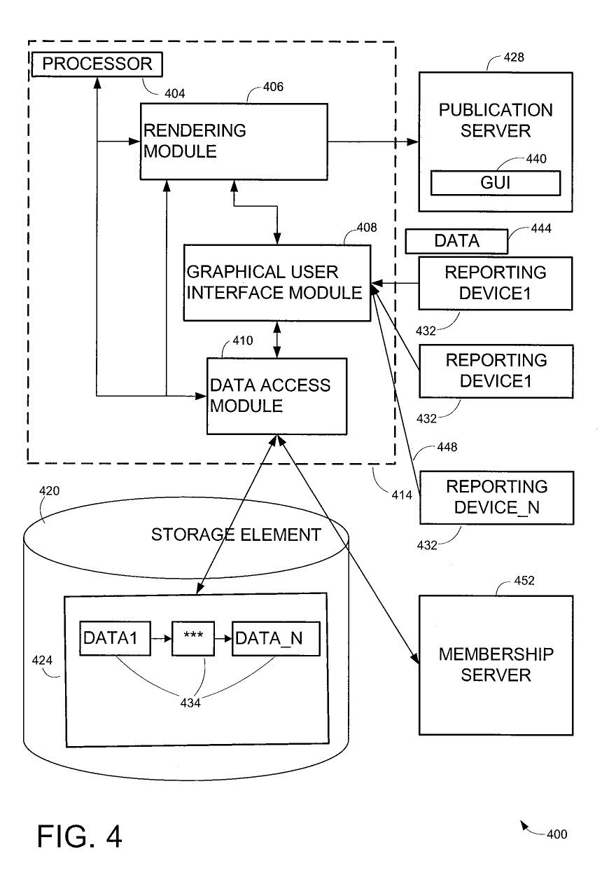

FIG. 4 is a block diagram of a system 400 according to various embodiments. The system 400 may include a number of modules such as one or more processors 404, a rendering module 406, a GUI module 408 and a data access module 410. The rendering module 406 and the GUI module 408 may take the form of an integral module, or exist as separate modules, as shown. These modules may be associated within a machine 414, such as a personal digital assistant (PDA), laptop computer, personal computer, workstation, client, or server, as indicated by their containment within the dashed box.

In order to avoid obscuring the components of FIG. 4, connecting lines between each of the elements within the machine 414 have not been shown. However, those of ordinary skill in the art will understand that any of the individual elements shown to be located within the confines of the machine 414 may be operably coupled to any other element within the machine 414. Similarly, those of ordinary skill in the art will understand that any of the components shown to be located within the confines of the machine 414 may also be located outside the machine 414, and appropriately coupled to the machine 414 via wired or wireless networks or other interface mechanisms.

The data access module 410 may be used by the rendering module 406 to access a storage element 420, such as a database, a memory, a disk, or other storage device. The storage element 420 may serve to contain one or more items having electronic content 424, such as consumption data sets 434. The data access module 410 may operate to read from and/or write to the electronic content 424 and may provide reading and writing services for the benefit of other system modules, including the GUI module 408, the rendering module 406, and the processor 404.

The data access module 410 may be present in some embodiments, and absent in others. When present, the data access module 410 may operate as a mediator between the various components of the system 400 and the electronic content 424. For example, the storage element 420 may be included in a remote server, such as a data aggregation server to aggregate consumption data 444 into the consumption data sets 434.

The rendering module 406 may be operably coupled to an output device 428, such as a publication server, client device, display screen, printer, or loudspeaker, among others. The output device 428 may be used for presenting renderings of the consumption data sets 434. Rendering may take the form of displaying the data sets 434, including a vertically or horizontally-oriented version of a ranked list that can be used to compare resource consumption by various entities, as described previously.

The GUI module 408 may be operably connected to the rendering module 406 and the data access module 410. The rendering module 406 may comprise a portable document format processing program in some embodiments.

The GUI module 408 may receive input from a variety of input devices 432 (e.g., a keyboard, a mouse, a trackball, voice recognizer, touch pad, touch screen, etc.). Such devices 432 may include one or more reporting devices, such as smart meters, client devices (e.g., desktop or laptop computers), servers, and other devices. Thus, many embodiments may be realized.

For example, a system 400 to collect and publish comparative resource consumption data may include an output device 428, comprising a client display, as well as a rendering module 406 to display electronic content 424 on the display as part of a GUI 440, which may be similar to or identical to either of the GUIs 108, 268 of FIGS. 1, 2, respectively. The system 400 may also include a storage element 420 to store instructions, which when executed, cause the rendering module 406 to display an online comparison of resource consumption data as part of the GUI 440, in accordance with the processes shown and described with respect to FIGS. 1-3. In most embodiments, the system 400 includes one or more input devices 428 to transmit resource consumption data 444 from a plurality of consuming entities.

Thus, in some embodiments, a system 400 may comprise a plurality of resource consumption reporting devices 432 to control consumption of one or more resources by resource consumption appliances on a per-appliance basis, and to collect resource consumption data 444 associated with the consumption of the one or more resources by the resource consumption appliances (not shown). The system 400 may further include one or more servers (e.g., included in machine 414) to receive the resource consumption data from the plurality of resource consumption devices 432.

The data 444 may be received via a global communications network 448. The server(s) 428, 452 may operate to publish an online comparison of at least some of the resource consumption data 444 and/or information derived from the resource consumption data 444 to compare consumption by at least three of the consuming entities forming at least a portion of an online community. In some embodiments, smart meters may be used to communicate with one or more servers over the Internet, so that the data may be subsequently published as a comparison within an online community. The meters, embodied as devices 432, may be configured to monitor an entire household or business, or individual appliances within a household or business, such as a data center, for example.

The server(s) may comprise at least one receiving server to receive the resource consumption data (e.g., as part of the machine 414), and at least one publication server 428 to publish the online comparison, perhaps as part of a GUI 440. In this way, multiple servers can be used to acquire the data 444, and to publish the data 444. The system 400 may also comprise at least one membership server 452 to manage membership in the online community.

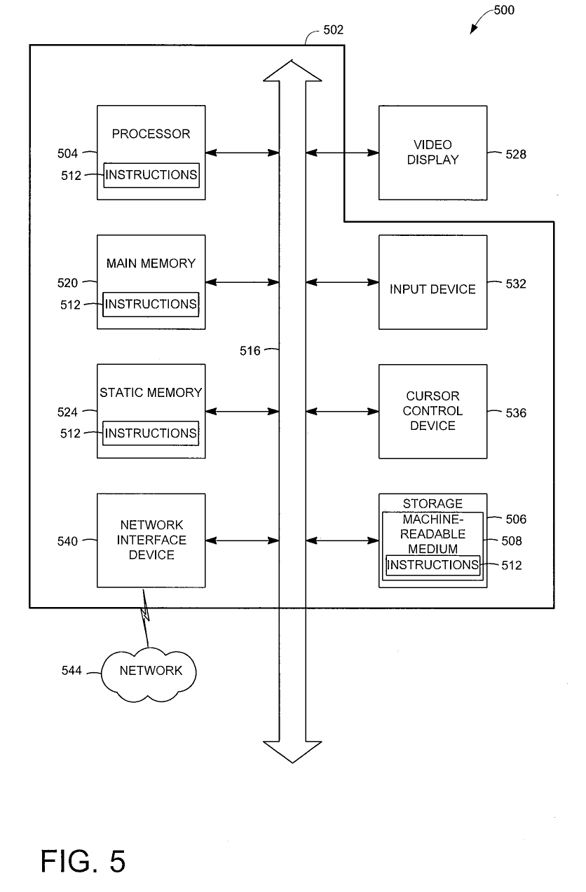

FIG. 5 is a block diagram of an article 500 of manufacture, including a machine 502, according to various embodiments. Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment.

Thus, other embodiments may be realized. For example, an article 500 of manufacture, such as a computer, a memory system, a magnetic or optical disk, some other storage device, and/or any type of electronic device or system may include one or more processors 504 coupled to a machine-readable medium 508 such as a memory (e.g., removable storage media, as well as any memory including an electrical, optical, or electromagnetic conductor) having instructions 512 stored thereon (e.g., computer program instructions), which when executed by the one or more processors 504 result in the machine 502 performing any of the actions described with respect to the methods above.

The machine 502 may take the form of a computer system having a processor 504 coupled to a number of components directly, and/or using a bus 516. Thus, the machine 502 may be similar to or identical to the machine 414 or system 400 shown in FIG. 4.

Turning now to FIG. 5, it can be seen that the components of the machine 502 may include main memory 520, static or non-volatile memory 524, and mass storage 506. Other components coupled to the processor 504 may include an input device 532, such as a keyboard, a cursor control device 536, such as a mouse. An output device 528, such as a video display, may be located apart from the machine 502 (as shown), or made as an integral part of the machine 502.

A network interface device 540 to couple the processor 504 and other components to a network 544 may also be coupled to the bus 516. The instructions 512 may be transmitted or received over the network 544 via the network interface device 540 utilizing any one of a number of well-known transfer protocols (e.g., HTTP). Any of these elements coupled to the bus 516 may be absent, present singly, or present in plural numbers, depending on the specific embodiment to be realized.

The processor 504, the memories 520, 524, and the storage device 506 may each include instructions 512 which, when executed, cause the machine 502 to perform any one or more of the methods described herein. In some embodiments, the machine 502 operates as a standalone device or may be connected (e.g., networked) to other machines. In a networked environment, the machine 502 may operate in the capacity of a server or a client machine in server-client network environment, or as a peer machine in a peer-to-peer (or distributed) network environment. The machine 502 may comprise a personal computer (PC), a tablet PC, a set-top box (STB), a PDA, a cellular telephone, a web appliance, a network router, switch or bridge, server, client, or any machine capable of executing a set of instructions (sequential or otherwise) that specify actions to be taken by that machine. Further, while only a single machine 502 is illustrated, the term “machine” shall also be taken to include any collection of machines that individually or jointly execute a set (or multiple sets) of instructions to perform any one or more of the methodologies discussed herein.

For example, in some embodiments, the instructions 512 may cause the machine to execute a computer-implemented method of monitoring competition among consuming entities, comprising receiving resource consumption data from a plurality of consuming entities that are members of an online community, publishing an online comparison of the resource consumption data and/or information derived from the resource consumption data as a ranked list comparing consumption by the consuming entities, and repeating the receiving and the publishing in order to inspire competition among the consuming entities to reduce consumption of resources associated with the resource consumption data.

While the machine-readable medium 508 is shown as a single medium, the term “machine-readable medium” should be taken to include a single medium or multiple media (e.g., a centralized or distributed database, and/or associated caches and servers, and or a variety of storage media, such as the registers of the processor 504, memories 520, 524, and the storage device 506 that store the one or more sets of instructions 512. The term “machine-readable medium” shall also be taken to include any medium that is capable of storing, encoding or carrying a set of instructions for execution by the machine and that cause the machine 502 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media. Still further embodiments may be realized.

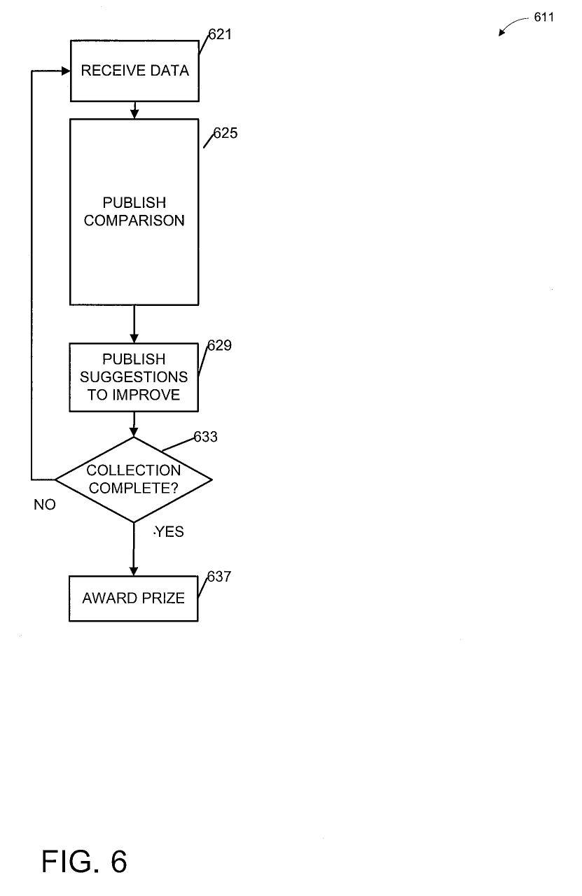

For example, FIG. 6 is a flow diagram illustrating additional methods 611 according to various embodiments. The methods 611 are implemented in a machine-accessible and readable medium, and are operational over processes within and among networks. The networks may be wired, wireless, or a combination of wired and wireless. The methods 611 may be implemented as instructions, which when accessed by a machine, cause the machine to perform the processing depicted and described with respect to FIGS. 1-2, as well as additional processing.

Thus, in some embodiments, a computer-implemented method 611 of collecting and publishing resource consumption data may comprise, at block 621, receiving resource consumption data from a plurality of consuming entities that are members of a defined community. A “defined community” means any defined collection of consuming entities, such as customers of a utility company; members of a neighborhood, block, or subdivision; purchasers of a specified builder's housing; members of an online community that have login privileges to a web site hosted at a specified URL, etc.).

The method 611 may continue on to block 625 with publishing a ranking to individual ones of the consuming entities, with respect to others of the consuming entities, based on a comparison of at least some of the resource consumption data and/or information derived from the resource consumption data to compare consumption by two or more (e.g., at least three) of the consuming entities.

In some embodiments, the activity of publishing at block 625 comprises publishing, by at one or more of a utility, a government agency, or an online service provider, the ranking of the individual consuming entities.

Publishing at block 625 may take the form of publishing, as feedback to individual consuming entities, changes in rank, consumption, or fees (e.g., the charges on an upcoming utility bill) based on a change in the resource consumption data and/or information derived from the resource consumption data associated with the individual consuming entities.

Publishing at block 625 may also include publishing, as feedback to individual consuming entities, a rank in a selected community based on the resource consumption data and/or information derived from the resource consumption data associated with the individual consuming entities. Thus, individual consuming entities may be informed of how they stand with respect to others in a community selected for them by the publisher, or selected by the consuming entities themselves. For example, a household might request feedback with respect to its ranking with respect to others in its zip code, or its block, or across the same utility company. Such feedback can be provided as part of the publishing activity.

As an original or follow-up activity, the method 611 may continue on to block 629 to include publishing, as feedback to individual consuming entities, suggestions to improve their rank in a selected community based on the resource consumption data and/or information derived from the resource consumption data associated with the individual consuming entities. Thus, for example, an individual household or business may be advised that watering from 10 pm to 4 am is more efficient, requiring less overall consumption, than watering from 2 am until 8 am, since more of the applied water will soak into the ground, rather than being evaporated by the morning sun. The savings in consumption may result in improving ranking.

The activity of receiving consumption data and publishing the comparison results, and/or suggestions to improve, may continue until the collection of the consumption data is complete, as determined at block 633. In some embodiments, the method 611 may include awarding prizes.

Thus, for example, a utility company might host an internet site to inspire competition among its customers, giving out prizes in the form of cash or energy credits to the customers that are most highly ranked over some specified period of time (e.g., one or more billing periods). Government agencies and online service providers, such as Internet service providers (ISPs), may individually (or perhaps collectively in conjunction with a utility company) do the same.

The activities of the method 611 may be applied in a serial, parallel, looped, and/or repetitious fashion, as well as substituted for or added to those illustrated in FIG. 3, so that still further embodiments may be realized.

Implementing the apparatus, systems, and methods of the various embodiments may thus encourage wide-ranging competition between entities to reduce resource consumption. Improved conservation of a variety of resources may result.

Although embodiments of the invention have been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those of ordinary skill in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Embodiments may, for example, be implemented as a stand-alone application (e.g., without any network capabilities), a client-server application or a peer-to-peer (or distributed) application. Embodiments may also, for example, be deployed by Software-as-a-Service (SaaS), Application Service Provider (ASP), or utility computing providers, in addition to being sold or licensed via traditional channels.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). Modules may include hardware circuitry, optical components, single or multi-processor circuits, memory circuits, software program modules and objects, firmware, and combinations thereof, as appropriate for particular implementations of various embodiments. The term “module” includes an identifiable portion of code, data, or a computational object to achieve a particular function, operation, processing, or procedure.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of ordinary skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed, is:

1. A computer-implemented method comprising:
receiving resource consumption data from a plurality of consuming entities that are members of an online community; and
publishing an online comparison of at least some of the resource consumption data and/or information derived from the resource consumption data to compare consumption by at least three of the consuming entities.

2. The method of claim 1, wherein the receiving comprises:
receiving the resource consumption data from a plurality of reporting devices over a network that couples the plurality of reporting devices to a publication server to publish the comparison.

3. The method of claim 1, wherein the resource consumption data is associated with consuming at least one of power, fuel, or water.

4. The method of claim 1, wherein the receiving comprises:
receiving the resource consumption data by at least one server; and
aggregating and ranking the resource consumption data to provide the comparison.

5. The method of claim 1, further comprising:
collecting the resource consumption data at a second web site from one or more first web sites where the resource consumption data is originally received.

6. The method of claim 1, further comprising:
transmitting the comparison from a first web site where the resource consumption data was originally received, to a second web site.

7. The method of claim 1, wherein the receiving comprises:
receiving the resource consumption data on at least one of a periodic basis or over a limited time period.

8. The method of claim 1, further comprising:
transmitting the resource consumption data from a plurality of networked reporting devices comprising at least one of a computer or a data acquisition terminal.

9. The method of claim 1, wherein the consuming entities comprise at least one of individual persons, households, structures, blocks, streets, subdivisions, zip codes, map grids, power grids, structure types, business types, business associations, clubs, Internet social networking groups, resource type users, cities, counties, states, or countries.

10. The method of claim 1, wherein the publishing comprises:
publishing the comparison as a ranked list.

11. The method of claim 10, wherein the ranked list identifies the consuming entities associated with the consumption data and/or the information.

12. The method of claim 10, wherein the ranked list is ordered with the consuming entities that consume less of a resource ranked higher than the consuming entities that consume more of the resource.

13. The method of claim 1, further comprising:
deriving the information from the resource consumption data by adjusting the resource consumption data based on at least one of household size, structure size, group size, business size, resource cost, resource type, resource provider, time of usage, climate data, temperature data, rainfall data, or business type.

14. The method of claim 1, wherein the publishing comprises:
publishing the comparison as part of an email message to the consuming entities.

15. The method of claim 1, wherein the publishing comprises:
publishing the comparison including a color-coded scale associated with the consumption data and/or the information.

16. The method of claim 15, further comprising:
awarding at least one prize having a value based on the color-coded scale.

17. The method of claim 1, further comprising:
awarding a prize to one or more winners of a contest based on the comparison.

18. A system comprising:
a plurality of resource consumption reporting devices to control consumption of one or more resources by resource consumption appliances on a per-appliance basis, and to collect resource consumption data associated with the consumption of the one or more resources by the resource consumption appliances; and
at least one server to receive the resource consumption data from the plurality of resource consumption devices via a global communications network, and to publish an online comparison of at least some of the resource consumption data and/or information derived from the resource consumption data to compare consumption by at least three of the consuming entities forming at least a portion of an online community.

19. The system of claim 18, wherein the at least one server comprises:
at least one receiving server to receive the resource consumption data; and
at least one publication server to publish the online comparison.

20. The system of claim 18, comprising:
at least one membership server to manage membership in the online community.

21. A computer-implemented method comprising:
receiving resource consumption data from a plurality of consuming entities that are members of an online community;
publishing an online comparison of the resource consumption data and/or information derived from the resource consumption data as a ranked list comparing consumption by the consuming entities; and
repeating the receiving and the publishing in order to inspire competition among the consuming entities to reduce consumption of resources associated with the resource consumption data.

22. A computer-implemented method comprising:
receiving resource consumption data from a plurality of consuming entities that are members of a defined community; and
publishing a ranking to individual ones of the consuming entities, with respect to others of the consuming entities, based on a comparison of at least some of the resource consumption data and/or information derived from the resource consumption data to compare consumption by at least three of the consuming entities.

23. The method of claim 22, wherein the publishing comprises:
publishing, by at least one of a utility, a government agency, or an online service provider, the ranking.

24. The method of claim 22, further comprising:
publishing, as feedback to the individual ones of the consuming entities, at least one of a change in rank, a change in consumption, or a change in fees based on a change in the resource consumption data and/or information derived from the resource consumption data associated with the individual ones of the consuming entities.

25. The method of claim 22, further comprising:
publishing, as feedback to the individual ones of the consuming entities, a rank in a selected community based on the resource consumption data and/or information derived from the resource consumption data associated with the individual ones of the consuming entities.

26. The method of claim 22, further comprising:
publishing, as feedback to the individual ones of the consuming entities, suggestions to improve a rank in a selected community based on the resource consumption data and/or information derived from the resource consumption data associated with the individual ones of the consuming entities.
